(19) United States
(12) Patent Application Publication
(10) Pub. No.: US 2015/0041229 A1
(43) Pub. Date: Feb. 12, 2015

(54) FRONT END ARRANGEMENT WITH ACTIVE RADIATOR DAMPER AND ACTIVE RADIATOR CONTROL METHOD

(71) Applicant: Honda Motor Co., Ltd., Tokyo (JP)

(72) Inventors: Michael W. Maurer, Novi, MI (US); Jesse Black, Marysville, OH (US); Brian Richard Reynolds, Dublin, OH (US)

(73) Assignee: Honda Motor Co., Ltd., Tokyo (JP)

(21) Appl. No.: 13/962,064

(22) Filed: Aug. 8, 2013

(51) Int. Cl. B60K 11/06; B60K 11/08; B60K 11/04

(52) U.S. Cl. CPC B60K 11/06; B60K 11/04; B60K 11/085
USPC 180/68.1; 454/152

(57) ABSTRACT

A front end arrangement and airflow control method for a vehicle includes a radiator disposed in an engine compartment of the vehicle and a damper disposed below the radiator for selectively controlling recirculation through the radiator. The damper is movable between an open position wherein airflow from behind the radiator recirculates by passing forwardly under the radiator and again through the radiator, and a closed position wherein the airflow from behind the radiator is substantially prevented from passing forwardly under the radiator and recirculating through the radiator.

### BACKGROUND

The present disclosure generally relates to a front end arrangement and method for a vehicle, and particularly relates to an active radiator control method and related front end arrangement for improved fuel economy.

Improving fuel economy is a continuous goal in vehicles. It is known that operating a vehicle with one or more of its operating fluids (e.g., automatic transmission fluid, engine oil, coolant, etc.) at a reduced temperature, such as during cold ambient conditions, has a negative impact on fuel economy. In particular, the viscosity of the operating fluids when the engine is first started from a cold condition is undesirably high. Heretofore, very expensive heat exchangers have been applied to vehicles to address these concerns. Such heat exchangers use coolant to warm one or more of the operating fluids on engine startup thereby reducing the viscosity of the fluids and improving the efficiency of the engine, including fuel efficiency.

### SUMMARY

According to one aspect, an active radiator control method is provided for improved fuel economy. More particularly, in accordance with this aspect, the method includes directing airflow entering an engine compartment of a vehicle through a radiator disposed in the engine compartment and selectively controlling recirculation of a portion of the airflow that is rearward of the radiator from passing below the radiator and back through the front side of the radiator. Selectively controlling recirculation includes closing a damper disposed below the radiator to prevent recirculation of the airflow that is rearward of the radiator, and opening the damper to allow the portion of the airflow to pass below the radiator and travel forwardly for passing back through the front side of the radiator and thereby recirculating through the radiator.

According to another aspect, a front end arrangement for a vehicle includes a radiator disposed in an engine compartment of the vehicle and a damper disposed below the radiator for selectively controlling recirculation through the radiator. The damper is movable between an open position wherein airflow from behind the radiator recirculates by passing forwardly under the radiator and again through the radiator, and a closed position wherein the airflow from behind the radiator is substantially prevented from passing forwardly under the radiator and recirculating through the radiator.

According to a further aspect, a front end airflow control method is provided for a vehicle. More particularly, in accordance with this aspect, the method includes admitting airflow into an engine compartment of the vehicle, directing the airflow admitted into the engine compartment through a radiator disposed within the engine compartment, opening a damper disposed below the radiator to recirculate the airflow through the radiator, and closing the damper to prevent recirculation of the airflow through the radiator.

### BRIEF DESCRIPTION OF THE DRAWINGS

FIG. 1 is a cross-sectional view of a front end structure for a vehicle having a damper (shown in a closed position) disposed below a radiator for selectively controlling recirculation through the radiator.

FIG. 2 is a cross-sectional view similar to FIG. 1, but showing the damper in an open position.

FIG. 3 is a cross-sectional view of the front end arrangement taken along the line 3-3 of FIG. 1.

FIG. 4 is a block diagram illustrating an active radiator control method for a vehicle.

### DETAILED DESCRIPTION

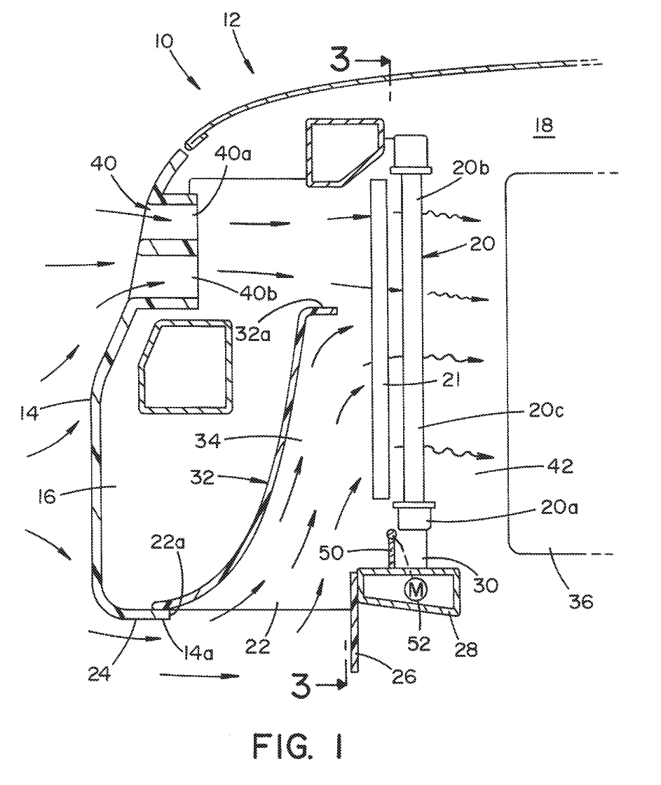

Referring now to the drawings, wherein the showings are for purposes of illustrating one or more exemplary embodiments and not for purposes of limiting same, FIGS. 1-3 illustrate a front end arrangement or structure 10 on a vehicle 12. The illustrated front end arrangement 10 includes a fascia member 14 defining a forward end 16 of an engine compartment 18 of the vehicle 12. A radiator 20 is disposed in the engine compartment 18 rearwardly of the fascia member 14, and particularly rearwardly spaced from the fascia member 14. A condenser 21 can be disposed immediately forward of the radiator 20 and an engine 36 can be disposed rearward of the radiator 20.

An underside air inlet opening 22 is defined in an underside 24 of the vehicle 12. In the illustrated embodiment, the underside air opening 22 is defined between a lower edge 14a of the fascia member 14 and another component (e.g., air dam member 26 attached to an underside bulkhead 28 in the illustrated embodiment), though this is not required. For example, in alternate embodiments, the underside air inlet opening could be defined in the fascia member 14, particularly in a portion extending and/or defining an underside of the vehicle, defined in another component spaced rearwardly of the fascia member 14, etc.

As is known and understood by those skilled in the art, the underside bulkhead 28 can be included as part of a frame of the vehicle 12 and thus can extend laterally across the engine compartment 18 to lateral sides of the vehicle at or adjacent the underside 22 of the vehicle and/or can be connected to other structural frame members of the vehicle 12. In the illustrated embodiment, the bulkhead 28 is disposed below the radiator 20 and extends laterally across the engine compartment 18. Further, the bulkhead 28 is spaced vertically below a lower end 20a of the radiator to define a radiator passage 30 for airflow to pass forwardly under the radiator 20 as will be described in more detail below. Also in the illustrated embodiment, the air dam member 26 depends from the bulkhead 28, particularly from a forward side of the bulkhead 28.

In the illustrated embodiment, a duct member 32 is interposed longitudinally between the fascia member 14 and the radiator 20. More particularly, the duct member 32 extends upward from a leading edge 22a of the opening 22, which is defined in the illustrated embodiment by the underside end 14a of the fascia member 14, and directs airflow entering the underside air inlet opening 22 toward the radiator 20. Also in the illustrated embodiment, the duct member 32 at least partially blocks the radiator 20 (i.e., blocks or inhibits at least some airflow from entering through the fascia 14, or openings therein, and passing directly to the radiator 20) and defines a duct passageway 34 extending from the underside opening 22 of the vehicle 12 to the radiator 20. In particular, and as shown, the duct member 32 can block airflow from entering a lower half of the radiator 20, or more particularly, a lower two-thirds of the radiator 20. Advantageously, this can allow the front fascia 14 to be closed along a corresponding vertical height thereof and, as will be described in more detail below, the size of the grille (e.g., grille 40 with grille openings 40a, 40b) can be minimized and provided only in alignment with an upper half or third of the radiator 20.

The grille opening 40 of the illustrated embodiment is defined in the fascia member 14 for directing airflow to the radiator 20 over the duct member 32. More specifically, the fascia member 14 can have a grille opening 40 with grille openings 40a, 40b defined therethrough for admitting airflow into the engine compartment 18, wherein the grille opening 40 is arranged so as to direct the airflow admitted therethrough toward an upper portion 20b of the radiator 20. In the illustrated embodiment, the grille opening 40 comprises the upper opening 40a and the lower opening 40b, though other arrangements and/or numbers of grille openings (e.g., one or more than two) could be provided.

As shown, airflow entering the grille openings 40a, 40b can pass directly to the radiator 20 over an upper end 32a of the duct member 30. This airflow path from the grille opening 40 defined in the fascia member 14 to the radiator 20 can be referred to as a first or grille airflow path. In the illustrated embodiment, the grille airflow path extends from the grille opening 40 to the radiator 20 and passes over the upper end 32a of the duct member 32. As shown, the duct member 32 can extend upward across a substantial portion of the radiator 20 in the illustrated embodiment reducing a cross-sectional area through which the grille airflow path passes. The duct member 32 can be arranged and configured to direct airflow admitted through the underside opening 22 toward a lower portion 20c of the radiator 20, the lower portion 20c bounded at one end by the lower end 20a. The radiator passage 30 defined below the radiator 20 fluidly connects a space 42 (i.e., space 42 being a portion of the engine compartment 18 disposed rearwardly of the radiator 20) to the duct passage 34.

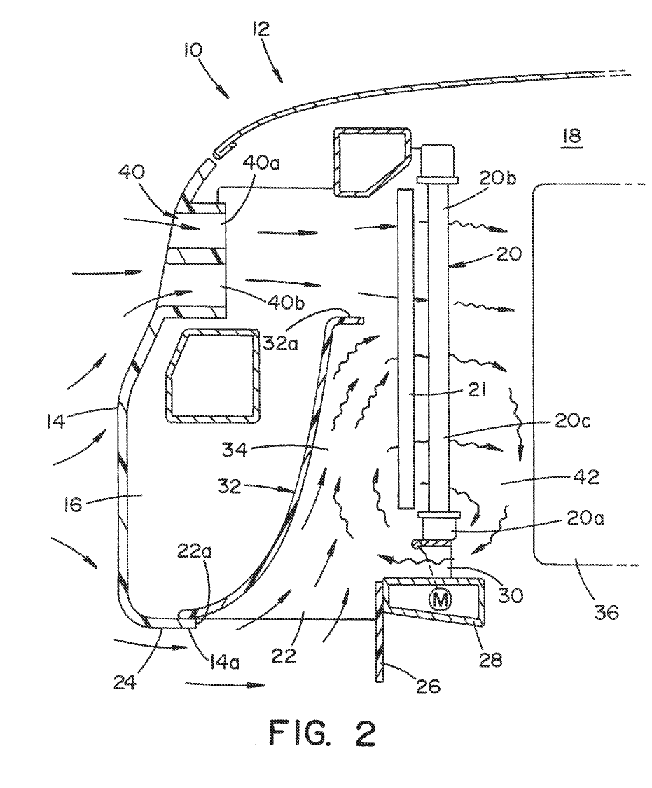

The front end arrangement 10 additionally includes a seal or damper 50 disposed below the radiator 20 for selectively controlling recirculation through the radiator 20. The damper 50 is disposed in or at one end of the radiator passage 30, as shown in the illustrated embodiment. The damper 50 is movable between an open position (FIG. 2) where an airflow from behind the radiator 20, such as at space 42, recirculates by passing forwardly under the radiator 20 and again through the radiator 20, and a closed position (FIG. 1) wherein the airflow from behind the radiator 20 at space 42 is substantially prevented from passing forwardly under the radiator 20 and then recirculating through the radiator 20. Forward of the damper 50 (e.g., in the duct passageway 34), there is a large low pressure section. When the damper 50 is open, the low pressure area sucks hot air, such as from space 42, from the engine compartment 18 forcing this hot air to be reused for cooling.

This recirculation process is very inefficient for engine cooling. However, and advantageously, this phenomenon can be used to improve fuel economy for the engine 36. More particularly, by allowing recirculation, the temperatures of one or more fluids of the vehicle, such as those associated with the engine 36, can be rapidly increased to thereby improve the efficiency of the engine 36. Examples of the fluids that can be rapidly increased include the automatic transmission fluid, engine oil and coolant, though other fluids may be advantageously affected. Once the fluids are up to or past predetermined temperatures, the damper 50 can be closed allowing the cooling system to behave in a normal, efficient manner. Thus, when the damper 50 is in the open position, the radiator passage 30 is passable so that airflow from space 42 can pass through the passage 30 to the duct passage 34. The radiator passage 30, however, is closed by the damper 50 when the damper 50 is in the closed position.

Accordingly, the damper 50 closes the passage 30 and prevents airflow therethrough when the damper 50 is in the closed position and allows airflow through the passage 30 when the damper 50 is in the open position. The portion of the airflow that passes back through the front side of the radiator when the damper is open also passes through the condenser 21 disposed forward of the radiator 20. Advantageously, the damper 50 can be moved to the open position during startup conditions for the engine 36 so that fluids associated with the engine 36 can heat up more quickly reducing viscosity and allowing the engine 36 to run more efficiently.

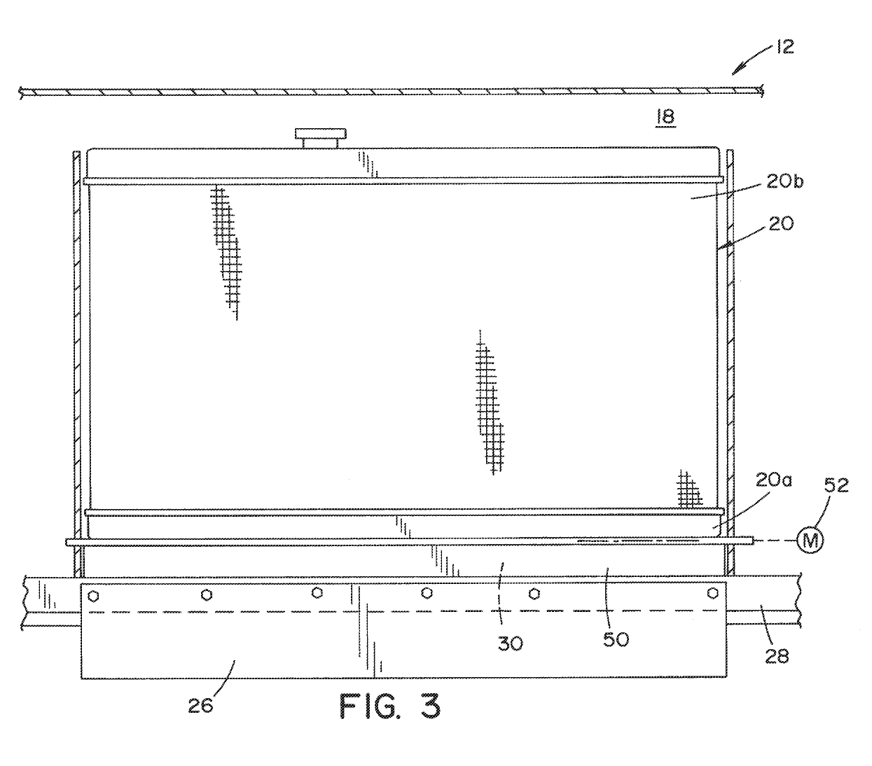

As shown, the front end arrangement 10 can include a motor 52 operatively connected to the damper 50 for powered movement of the damper 50 between the open position and the closed position. The motor 52 can be controlled by a controller (not shown) that moves the damper toward or to the open position, the closed position, or optionally any position therebetween. Operation of the motor and thereby the damper 50 can be as described hereinbelow. As best shown in FIG. 3, the damper 50 can extend along substantially an entire lateral width of the radiator 20 along the lower end or edge 20a of the radiator 20, though this is not required.

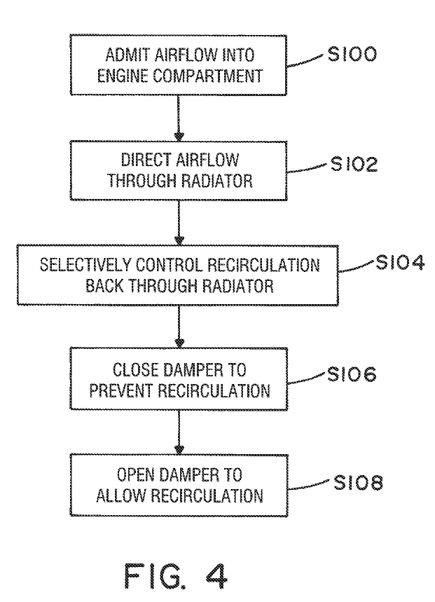

With reference now to FIG. 4, an active radiator control method will now be described for improved fuel economy for a vehicle. In particular, the method of FIG. 4, which can also be referred to as a front end airflow control method for a vehicle, will be described in association with the front end arrangement 10 described above in reference to FIGS. 1-3, though it is to be appreciated by those skilled in the art that the method could be employed with other front end arrangements. As shown in FIG. 4, airflow can be admitted into the engine compartment 18 of the vehicle 12 in S100. The admitting of airflow into the engine compartment 18 can include admitting a first airflow through the grille 40 defined in the fascia 14 of the vehicle 12 and admitting the second airflow through the underside opening 22 of the vehicle. Next, in S102, the airflow admitted or entering the engine compartment 18 of vehicle 12 can be directed through the radiator 20 disposed within the engine compartment 18. Directing the airflow entering the engine compartment 18 through the radiator 20 can include directing the first airflow or airflow portion entering through the grille 40 of the vehicle 12 through an upper portion 20b of the radiator 20 and directing the second airflow or airflow portion entering through the underside opening 22 of the vehicle through the lower portion 20c of the radiator 20.

The method of FIG. 4 can further include selectively controlling recirculation of a portion of the airflow that is rearward of the radiator 20 from passing below the radiator 20 and back through the front side of the radiator 20 in S104. Selectively controlling recirculation can include closing the damper 50 disposed below the radiator 20 to prevent recirculation of the airflow that is rearward of the radiator 20, as shown in S106. That is, the damper 50 can be closed to prevent recirculation of airflow through the radiator 20 in S106. Selectively controlling recirculation can also include opening the damper 50 to allow the portion of the airflow to pass below the radiator 20 and travel forwardly for passing back through the front side of the radiator 20 and thereby recirculate through the radiator 20 as shown in S108. That is, the damper 50 can be opened to recirculate the airflow through the radiator 20 in S108.

More particularly, opening of the damper 50 in S108 causes the portion of the airflow passing below the radiator 20 and traveling forwardly to mix with the second airflow portion entering the radiator from the underside opening 22 through the duct passageway 34 defined by the duct member 32 and passed together through the front side of the radiator 20, particularly the lower portion 20c thereof, with the second airflow portion. Thus, the airflow that recirculates via the radiator passage 30 when the damper 50 is open mixes with the second airflow entering the engine compartment 18 through the underside opening 22 and being directed to the lower portion 20c of the radiator 20 by the duct member 32.

As described above, the damper 50 can be motor driven by the motor 52 such that closing and opening of the damper 50 occurs when the motor 52 is actuated. Operation of the motor 52 can be controlled via a controller (not shown). In particular, and through the controller, opening of the damper 50 can occur when the engine 36 disposed in the engine compartment 18 is cool which allows the portion of the airflow recirculating through the radiator 20 to rapidly increase temperatures of fluids associated with the engine 36 to improve fuel economy for the vehicle 12. For example, closing of the damper 50 can occur when a predetermined temperature is reached. More particularly, in one embodiment, closing of the damper 50 occurs when the engine 36 is above a predetermined temperature. This could be determined by a sensor (e.g., an engine coolant temperature sensor) and fed to the motor controller.

More specifically, opening the damper 50 decreases the cooling efficiency of the radiator 20 thereby causing rapid heating of one or more fluids of the vehicle. That is, the airflow that has already passed through the radiator 20, or a portion thereof (such that occupies space 42), passes back through the radiator passage 30 when the damper 50 is open and mixes with the airflow entering through the underside opening 22 and being directed by the duct member 32 into the lower portion 20c of the radiator 20. The mixing of the already heated airflow with the fresh airflow decreases the efficiency of the radiator 20, particularly as compared to the situation where only fresh ambient airflow is directed to the radiator 20. In particular, the rapid heating of one or more fluids of the vehicle results in improved fuel economy for the vehicle 12. Specifically, rapid heating of the fluids associated with the vehicle 12 results in reduced viscosity for these fluids which enables the engine 36 to operate more efficiently.

During this period, the cooling efficiency of the radiator 20 is reduced, but this is not a concern due to the engine 36 starting from a relatively cool temperature. In one embodiment, opening of the damper 50 occurs upon start up of the vehicle 12 and closing of the damper 50 occurs when the one or more fluids are above a predetermined temperature. Such a determination as to when the one or more fluids are above predetermined temperatures can occur by using engine temperature. More specifically, it can be determined when the engine 36 is at or above a specific temperature, it can be presumed that the one or more fluids are also at or above respective predetermined temperatures for improving fuel efficiency of the engine 36. Once the one or more fluids are sufficiently warmed up and/or before the engine requires the radiator 20 to be fully efficient for cooling thereof, the damper 50 can be closed to allow the radiator 20 to behave in a conventional and efficient manner.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An active radiator control method for improved fuel economy, comprising:
directing airflow entering an engine compartment of a vehicle through a radiator disposed in the engine compartment;
selectively controlling recirculation of a portion of the airflow that is rearward of the radiator from passing below the radiator and back through the front side of the radiator, said selectively controlling recirculation including:
closing a damper disposed below the radiator to prevent recirculation of the airflow that is rearward of the radiator, and
opening the damper to allow the portion of the airflow to pass below the radiator and travel forwardly for passing back through the front side of the radiator and thereby recirculateing through the radiator.

2. The active radiator control method of claim 1 wherein opening said damper occurs when an engine disposed in the engine compartment is cool and the portion of the airflow recirculating through the radiator rapidly increases temperatures of fluids associated with the engine to improve fuel economy.

3. The active radiator control method of claim 2 wherein closing the damper occurs when the engine is above a predetermined temperature.

4. The active radiator control method of claim 1 wherein directing airflow entering the engine compartment through the radiator includes:
directing a first airflow portion entering through a grille of the vehicle through an upper portion of the radiator; and
directing a second airflow portion entering through an underside duct opening of the vehicle through a lower portion of the radiator.

5. The active radiator control method of claim 4 wherein opening the damper causes the portion of the airflow passing below the radiator and traveling forwardly to mix with the second airflow portion and pass through the front side of the radiator with the second airflow portion.

6. The active radiator control method of claim 1 wherein the damper is motor driven such that closing and opening the damper occurs when a motor is actuated.

7. The active radiator control method claim 1 wherein opening the damper decreases the cooling efficiency of the radiator thereby causing rapid heating of one or more fluids of the vehicle.

8. The active radiator control method of claim 7 wherein opening the damper occurs upon startup of the vehicle and closing the damper occurs when the one or more fluids are above predetermined temperatures.

9. The active radiator control method of claim 1 wherein the portion of the airflow that passes back through the front side of the radiator when the damper is open also passes through a condenser disposed forward of the radiator.

10. A front end arrangement for a vehicle, comprising:
a radiator disposed in an engine compartment of the vehicle;
a damper disposed below the radiator for selectively controlling recirculation through the radiator, the damper movable between an open position wherein airflow from behind the radiator recirculates by passing forwardly under the radiator and again through the radiator, and a closed position wherein the airflow from behind the radiator is substantially prevented from passing forwardly under the radiator and recirculating through the radiator.

11. The front end arrangement of claim 10 further including a bulkhead disposed below the radiator and extending laterally across the engine compartment, the bulkhead spaced vertically below a lower end of the radiator to define a radiator passage for airflow to pass forwardly under the radiator when the damper is in the open position, the passage closed by the damper when the damper is in the closed position.

12. The front end arrangement of claim 11 wherein an air dam depends from the bulkhead.

13. The front end arrangement of claim 10 further including a fascia member defining a forward end of the engine compartment, the radiator rearwardly spaced from the fascia member, the fascia member having a grille opening defined therethrough for admitting airflow into the engine compartment, the grille opening arranged so as to direct the airflow admitted therethrough toward an upper portion of the radiator.

14. The front end arrangement of claim 13 further including a duct member interposed between the fascia member and the radiator, the duct member at least partially blocking the radiator and defining a duct passage extending from an underside opening of the vehicle to the radiator.

15. The front end arrangement of claim 14 wherein the duct member is arranged and configured to direct airflow admitted through the underside opening toward a lower portion of the radiator, a radiator passage defined below the radiator that fluidly connects a space behind the radiator to the duct passage, the damper closing the passage and preventing airflow therethrough when the damper is in the closed position and allowing airflow through the passage when the damper is in the open position.

16. The front end arrangement of claim 10 further including a motor operatively connected to the damper for powered movement of the damper between the open position and the closed position.

17. The front end arrangement of claim 10 wherein the damper extends along substantially an entire lateral width of the radiator along a lower edge of the radiator.

18. A front end airflow control method for a vehicle, comprising:
admitting airflow into an engine compartment of the vehicle;
directing the airflow admitted into the engine compartment through a radiator disposed within the engine compartment;
opening a damper disposed below the radiator to recirculate the airflow through the radiator; and
closing the damper to prevent recirculation of the airflow through the radiator.

19. The front end airflow control method of claim 18 wherein admitting airflow into the engine compartment includes admitting a first airflow through a grille defined in a fascia of the vehicle and admitting a second airflow through an underside opening of the vehicle, the airflow that recirculates when the damper is open mixes with the second airflow.

20. The front end airflow control method of claim 19 wherein closing the damper occurs when a predetermined temperature is reached.
